(19) United States
(12) Patent Application Publication
(10) Pub. No.: US 2022/0266704 A1
(43) Pub. Date: Aug. 25, 2022

(54) SYSTEMS AND METHODS FOR ELECTRIC VEHICLE POWER EXPORTER

(71) Applicant: Honda Motor Co., Ltd., Tokyo (JP)

(72) Inventor: Takeshi Kobayashi, Redondo Beach, CA (US)

(21) Appl. No.: 17/184,287

(22) Filed: Feb. 24, 2021

(51) Int. Cl. B60L 53/16; B60L 53/30; B60L 53/62; B60L 53/66

(52) U.S. Cl. CPC B60L 53/16; B60L 53/305; B60L 53/62; B60L 53/66

(57) ABSTRACT

A device for providing power is provided. The device includes a power inlet electrically connected to a power storage device of vehicle and a power outlet connected to a power consumer. The power is being routed from the power storage device of the vehicle to the power inlet and out of the power outlet to the power consumer. The device also includes a display and at least one processor in communication with at least one memory device. The at least one processor is programmed to determine a current charge state of the power storage device, determine a current available range for the vehicle based on the current charge state of the power storage device, and instruct said display to display the current available range.

### BACKGROUND

The field relates generally to power exporters, and more specifically, to using a power exporter with an electric or hybrid vehicle to safely provide power to a user device.

Over the past few years, electric and hybrid vehicles are becoming more prevalent. These vehicles include relatively large battery storage devices for storing electric power. In some cases, users would like to use this portable energy source for other purposes, such as for powering electrical devices while camping, providing power at a worksite, and providing power to a domicile during a power outage. However, many of the power converters on the market are expensive, heavy, and/or do not provide the proper amount of power for most commercial electronics. Accordingly, a more cost-effective and lightweight alternative is desired.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

In one aspect, a device for providing power is provided. The device includes a power inlet electrically connected to a power storage device of a vehicle and a power outlet connected to a power consumer. The power is being routed from the power storage device of the vehicle to the power inlet and out of the power outlet to the power consumer. The device also includes a display and at least one processor in communication with at least one memory device. The at least one processor is programmed to determine a current charge state of the power storage device, determine a current available range for the vehicle based on the current charge state of the power storage device, and instruct said display to display the current available range.

In another aspect, a method for providing power is provided. The method includes routing power from a power storage device of a vehicle to a power exporter, routing power from the power exporter to a power consumer, determining a current charge state of the power storage device, determining a current available range for the vehicle based on the current charge state of the power storage device, and transmitting, via a communication interface, the current available range to a user computer device, where the user computer device is configured display the current available range to a user.

In a further aspect, a system for providing power is provided. The system includes a power exporter configured to route power from a power storage device of a vehicle to a power consumer and a user computer device in communication with the power exporter. The user computer device includes at least one processor in communication with at least one memory device. The at least one processor is programmed to receive, from the power exporter, a current charge state of the power storage device, determine a current available range for the vehicle based on the current charge state of the power storage device, and instruct a display of at least one of the power exporter and the user computer device to display the current available range.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

The Figures described below depict various aspects of the systems and methods disclosed therein. It should be understood that each Figure depicts an example of a particular aspect of the disclosed systems and methods, and that each of the Figures is intended to accord with a possible example thereof. Further, wherever possible, the following description refers to the reference numerals included in the following Figures, in which features depicted in multiple Figures are designated with consistent reference numerals.

There are shown in the drawings arrangements, which are presently discussed, it being understood, however, that the present examples are not limited to the precise arrangements and instrumentalities shown, wherein:

FIG. 1 illustrates a schematic diagram of an exemplary vehicle, in accordance with one example of the present disclosure.

FIG. 2 illustrates a schematic diagram of an exemplary power exporter.

FIG. 3 illustrates a view of the exemplary power exporters shown in FIG. 3.

FIG. 4 illustrates a diagram of a process for discharging power from the vehicle shown in FIG. 1 using the power exporter shown in FIG. 2.

FIG. 5 illustrates a process for discharging power from the vehicle shown in FIG. 1 using the power exporter shown in FIG. 2.

FIG. 6 illustrates a simplified block diagram of a power exporter system for monitoring and controlling discharging power from the vehicle shown in FIG. 1 using the power exporter shown in FIG. 2.

FIG. 7 illustrates an example configuration of a user computer device used in the system shown in FIG. 6, in accordance with one example of the present disclosure.

### DETAILED DESCRIPTION

The field relates generally to power exporters, and more specifically, to using a power exporter with an electric or hybrid vehicle to safely provide power to a user. In one example, a power exporter is plugged in a charged electric vehicle. The power exporter includes an input port for receiving power from the electric vehicle and one or more output ports for exporting power. In the exemplary embodiment, the power exporter is attached to the vehicle at the recharging port. The power exporter regulates the power being distributed from the vehicle. The power exporter also includes a display for displaying information to the user. In the exemplary embodiment, the display includes a display for the amount of range that the vehicle may travel based on the current amount of charge in the electric vehicle.

In some embodiments, the power exporter is in communication with a user computer device, such as a smartphone, of the user. The power exporter informs the user, through the user computer device, of one or more of the state of charge of the vehicle, the distance that the vehicle may travel on the current charge, the distance to the nearest charging station, and how quickly the charge is being depleted. Moreover, in some embodiments the power exporter and/or user computer device are configured to monitor the distance that the vehicle may travel on the current charge, determine a distance between the power exporter and a charging station (e.g., nearest charging station or a home charging station), compare the distance that the vehicle may travel on the current charge to the distance between the power exporter and charging station, and provide predefined alerts to the user computer device based on that comparison.

Described herein are computer systems such as the user computer device, the power exporter controller, and related computer systems. As described herein, such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

The systems and processes are not limited to the specific examples described herein. In addition, components of each system and each process can be practiced independent and separate from other components and processes described herein. Each component and process also can be used in combination with other assembly packages and processes.

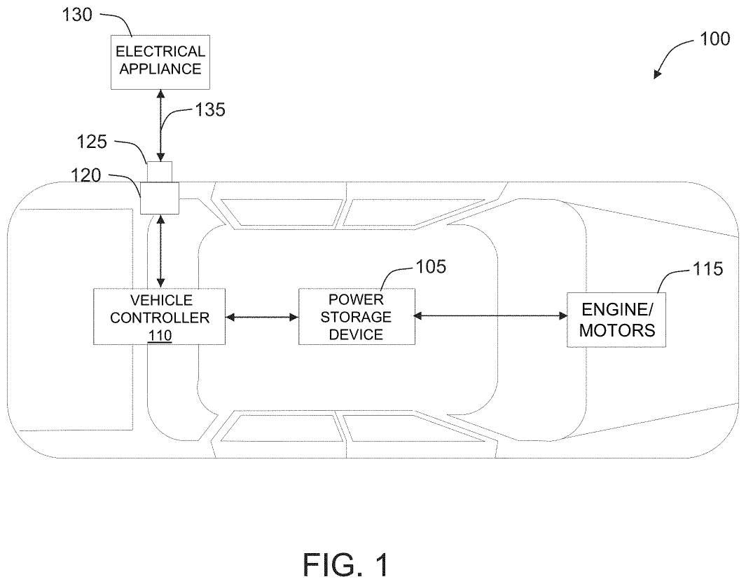

FIG. 1 depicts a view of an exemplary vehicle 100. In some embodiments, the vehicle 100 may be an autonomous or semi-autonomous vehicle capable of fulfilling the transportation capabilities of a traditional automobile or other vehicle. In these embodiments, the vehicle 100 may be capable of sensing its environment and navigating without human input. In other embodiments, the vehicle 100 is a manual vehicle, such as a traditional automobile that is controlled by a driver.

The vehicle 100 also includes power storage device 105, such as through one or more batteries or other power storage devices. The vehicle 100 is at least one of, but not limited to, a hybrid vehicle, an electric vehicle, a fuel cell vehicle, or other vehicle that stores electrical power in a power storage device 105, where the electrical power from the power storage device 105 is used by an engine/motor 115 to propel and drive the vehicle 100. In some embodiments, the vehicle 100 is also able to charge the power storage device 105, such as, but not limited to, via torque of the wheels and/or via the rotation of the engine/motors 115.

Note that while FIG. 1 illustrates a configuration provided with a single motor generator, the number of motor generators is not limited thereto, and a single motor generator or three or more motor generators may be provided. Furthermore, vehicle 100 may be an electric vehicle which does not have an engine mounted therein, or may be a fuel-cell vehicle.

In the exemplary embodiment, a vehicle controller 110 controls the operation of the vehicle 100. The vehicle controller 110 is in communication with the power storage device 105 and the engine/motors 115. The vehicle controller 110 coordinates transmitting power from the power storage device 105 to the engine/motors 115 to operate the vehicle 100. The vehicle controller 110 is also in communication with a power inlet/outlet 120 for the vehicle 100. The power inlet/outlet 120 is configured to receive power from an external power supply, such as a building electrical system or a specially configured charging device. The vehicle controller 110 routes the externally provided power to the power storage device 105 to charge the power storage device 105. The power inlet/outlet 120 is also configured to transmit power from the power storage device 105 through a power exporter 125 that is coupled to the power inlet/outlet 120. The power exporter 125 may then monitor and control the flow of power from the vehicle 100 to one or more power consumers 130 (aka electrical appliances) through a power cable 135. The power consumers 130 may include electrical appliances such as, but are not limited to, lights, fans, refrigerators, microwave ovens, televisions and other entertainment appliances, power tools, charging stations for portable electrical devices, and any other desired electrical appliance. In the camping situation, the power consumers 130 may include electrical appliances that may be used around the campsite, such as lights, insect repellant devices, and entertainment devices. In the worksite situation, the power consumers 130 may include electrical appliances such as power tools and their charging stations. In the power outage situation, the power consumers 130 may include electrical appliances such as refrigerators and other food storage appliances, as well as cellphones, and battery rechargers, such as for flashlights. In some further embodiments, the power consumer 130 could be a second vehicle that the vehicle 100 is charging.

In the exemplary embodiment, the power exporter 125 is in communication with one or more of the vehicle controller 110 and the power storage device 105. The power exporter 125 is configured to instruct one or more of the vehicle controller 110 and the power storage device 105 to allow power to flow from the power storage device 105 through the power inlet/outlet 120 to the power exporter 125. The power exporter 125 is also able to receive charge state information about the power storage device 105. The charge state can include a percentage of total charge of the power storage device 105 or a raw value of charge remaining in the power storage device 105, such as in kWh (kilowatt-hours).

While the vehicle 100 may be an automobile in the exemplary embodiment, in other embodiments, vehicle 100 may be, but is not limited to, other types of ground craft, aircraft, and watercraft vehicles.

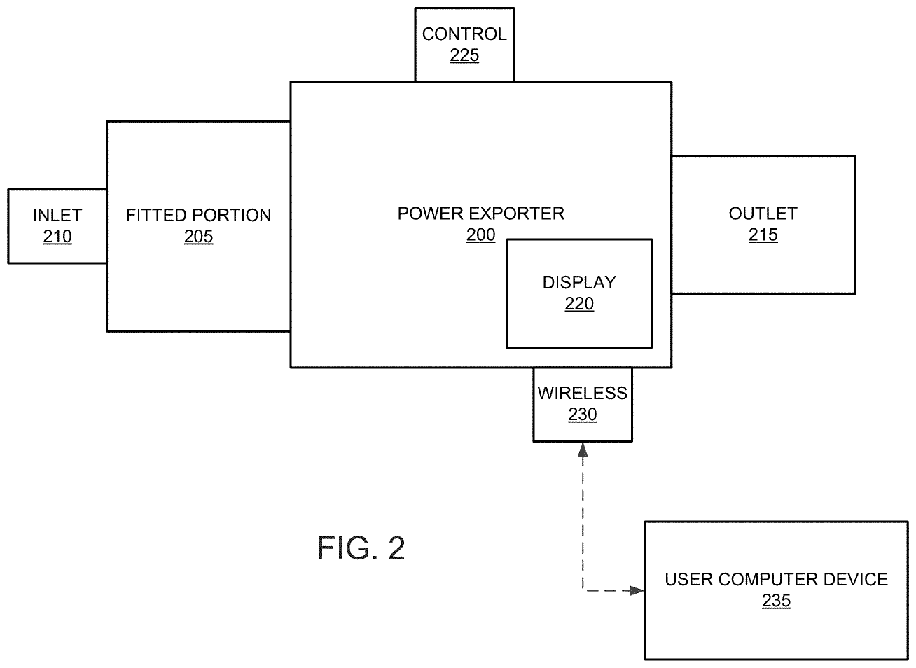

FIG. 2 illustrates a schematic diagram of an exemplary power exporter 200, such as power exporter 125 (shown in FIG. 1). In the exemplary embodiment, the power exporter 200 includes a fitted portion 205 for fitting securely into the power inlet/outlet 120 (shown in FIG. 1) of the vehicle 100 (shown in FIG. 1). The fitted portion 205 is configured to allow an inlet 210 of the power exporter 200 to make electrical contact with the power inlet/outlet 120. The inlet 210 is capable of receiving power from the power storage device 105 (shown in FIG. 1) of the vehicle 100. The power exporter 200 also includes an outlet 215 for outputting the power received from the vehicle 100. The output 215 is configured to connect to one or more electrical cords, such as cord 135, to provide power to one or more power consumers 130 (both shown in FIG. 1). The outlet 215 may include traditional electrical outlets, such as, 15 amp receptacles. In some embodiments, the outlet 215 also includes other types of outlets, such as, but not limited to, USB-A, USB-B, mini-USB, micro-USB, USB-C, lightning cable, and/or any other type of charging ports. The outlet 215 may include any combination of the above described outlet types.

In the exemplary embodiment, the power exporter 200 also includes a display 220, at least one control 225, and a wireless communicator 230 for communicating with a user computer device 235. The display 220 may include, but is not limited to, an LED numerical display, one or more LED indicator lights, a liquid crystal display (LCD), a LED backlit LCD, a thin-film transistor display, an electroluminescent display, or any other type of display 220 that allows the power exporter 200 to perform as described herein. The control 225 may include a switch, a slide control, a button, a trigger, or any other control 225 that allows the power exporter 200 to perform as described herein. The wireless communicator 230 may include, but is not limited to, Bluetooth, Bluetooth low energy, frequency identification (RFID), magnetic loop induction, high frequency audio, or other signals that allow communication between the power exporter 200 and the user computer device 235.

The display 220 is configured to display to a user the current available range remaining in the vehicle 100. In the exemplary embodiment, the current available range is based on the charge state of the power storage device 105 of the vehicle 100. In some embodiments, the current available range is based on the average distance of travel per charge for that type of vehicle 100. In some further embodiments, the power exporter 200 is capable of communicating with a user computer device 235to determine the average distance traveled by the vehicle 100 on a charge. In other embodiments, the power exporter 200 includes one or more user settings that may be set by the user and then stored in a memory in the power exporter 200. The user setting may be set by one or more of the controls 225 and the user computer device 235.

In some further embodiments, the display 220 may also display other information to the user. In these embodiments, the display 220 may indicate if the current available range of the vehicle 100 is sufficient to drive home. If the current available range is not sufficient to drive home, the display may indicate if the current available range based on the charge state is sufficient to drive to a nearby charging station. In these embodiments, the power exporter 200 may receive information from the user computer device 235. For example, the connected user computer device 235 may include a GPS (global positioning system) and can provide the current location of the vehicle 100. The user computer device 235 may also provide the distance to the user's home (or other location, such as a hotel) and the distance to the nearest charging station. In these embodiments, the power exporter 200 may stop transmission of power from the vehicle 100 when current available range or the charge state reaches the amount of charge needed to travel to the nearest charging station. In these embodiments, the range or charge needed includes a safety buffer of extra range and/or charge.

The control 225 allows the user to control whether or not the power exporter 200 is providing power. The control 225 may be a button, switch, trigger, or other controller that allows the user to turn the flow of power on and off. The control 225 may also control the operation of other functionality as well, such as, but not limited to, turning on and off wireless connectivity, turning on and off one or more warnings, and/or providing a way for the user to set one or more user settings. In some embodiments, the control 225 and the display 220 are combined, such as in the case of a touchscreen.

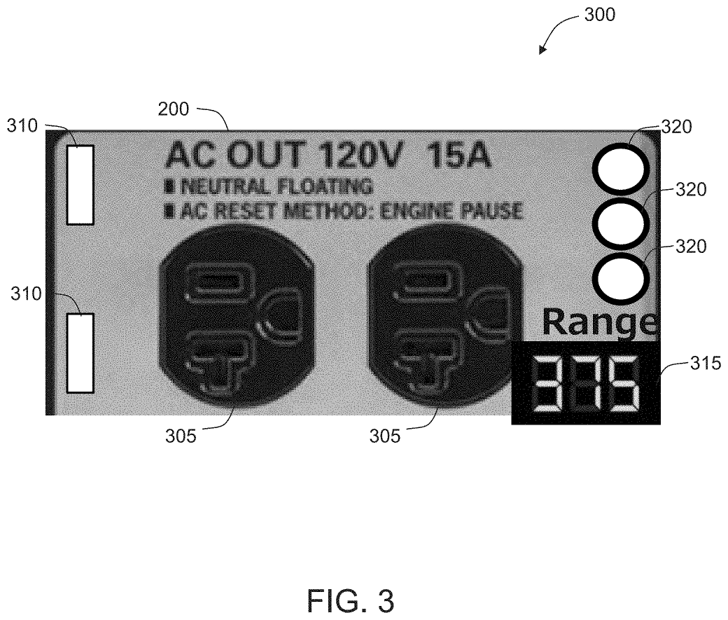

FIG. 3 illustrates a view 300 of the exemplary power exporters 200 (shown in FIG. 3). View 300 illustrates a potential configuration of the outlet 215 side (shown in FIG. 2) of the power exporter 200.

View 300 shows two different types of outlets 215. Receptacle outlets 305 are traditional electrical outlets, such as, 15 amp receptacles. These receptacle outlets 305 allow a user to plug in a traditional power consumer 130 (shown in FIG. 1), such as an electronic appliance. Port outlets 310 allow for the charging of computer-style electronics, such as cellphones, tablets, and other USB charged devices. In some embodiments, the port outlets may include other types of outlets, such as, but not limited to, USB-A, USB-B, mini-USB, micro-USB, USB-C, lightning cable, and/or any other type of charging ports.

View 300 also shows two different types of displays 220 (shown in FIG. 2). A range display 315 shows the current available range for the vehicle 100 (shown in FIG. 1) based on the current charge state of the vehicle 100. The current available range may be displayed in miles or kilometers based on user preferences. One or more status displays 320 show information about the power exporter 200. For example, at least one of status displays 320 may be configured to show whether or not power is flowing. Another of the status displays 320 may be lit up to show that there is a fault. A further status display 320 may be lit up to show that the current available range of the vehicle 100 is sufficient to reach the user's home location. Yet another of the status displays 320 may be lit up to indicate that the current available range of the vehicle is not enough to reach the user's home location, but is enough to reach the nearest charging station. An additional status display 320 may indicate that the current available range of the vehicle is sufficient to reach the nearest charging station, but the range is low enough that no more power may be transmitted from the vehicle 100 or the vehicle 100 might not be able to reach the nearest charging station.

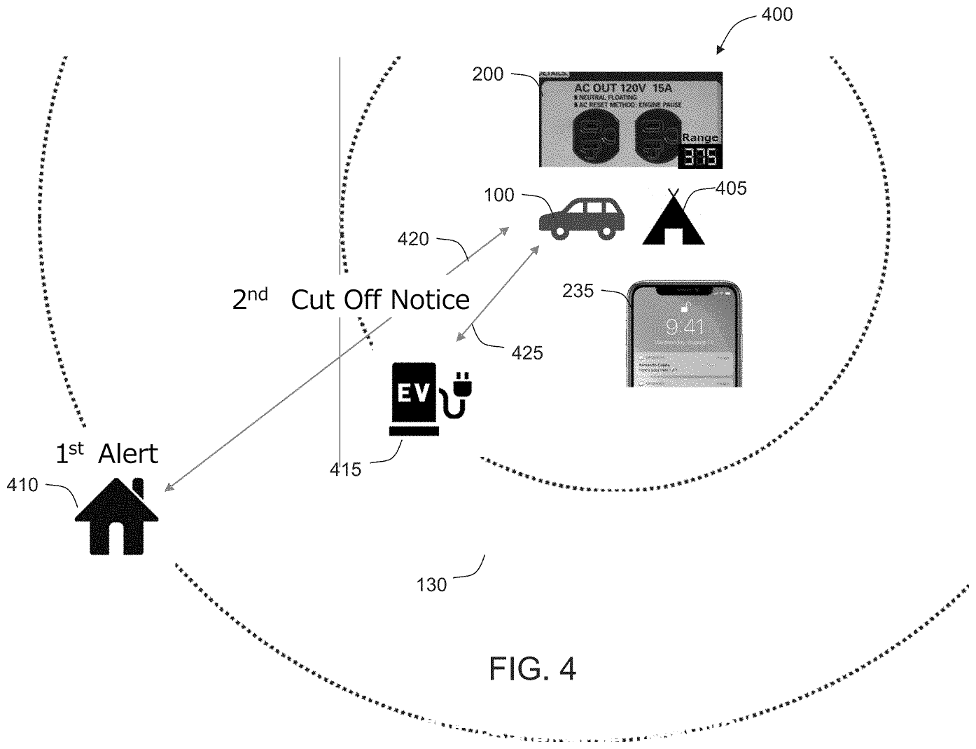

FIG. 4 illustrates a diagram of a process 400 for discharging power from the vehicle 100 (shown in FIG. 1) using the power exporter 200 (shown in FIG. 2). In FIG. 4, the power exporter 200 is in use to provide power at a campsite or other current location 405. The power exporter 200 is in wireless communication with one or more user computer devices 235 (shown in FIG. 2).

In the exemplary embodiment, the power exporter 200 transmits the current charge state to the user computer device 235. The user computer device 235 includes an installed application for interfacing with and managing the power exporter 200. The user computer device 235 determines the current location 405. In some embodiments, the user inputs the current location 405. In other embodiments, the user computer device 235 includes a GPS or other location detection technology to determine the current location 405 of the user computer device. In some further embodiments, the current location 405 is provided by the vehicle 100 and/or a GPS or other location detection technology included within the power exporter 200.

The user computer device 235 stores a home location 410 for the user and/or the vehicle 100. The home location 410 may the user's home, a hotel that the user is staying at, a business office, a next campsite, or any other location that represents a home base (permanent or temporary) for the vehicle. The home location 410 may also be where the vehicle 100 generally is recharged. The user computer device 235 determines a first distance 420 from the current location 405 to the home location 410. For example, the user computer device 235 may interact with a mapping application to map out a route from the current location 405 to the home location 410. Then the user computer device 235 uses that route to determine the first distance 420. The first distance 420 may include a buffer distance, such as 10% or five miles to ensure that the vehicle 100 can travel that first distance 420.

The user computer device 235 determines a nearest charging station 415 from the current location 405. The user computer device 235 may interact with a mapping program or a charging station locator program to determine where there are charging stations nearby. Then the user computer device 235 determines which charging station is the nearest. In some embodiments, the user computer device 235 detects the nearest charging station 415 on the route to the home location 410. The user computer device 235 may calculate the distance out of the user's way that the different charging stations are before determining which is the nearest. In still further embodiments, the user computer device 235 displays a plurality of nearby charging stations and allows the user to pick the nearest charging station 415. The user computer device 235 determines a second distance 425 from the current location 405 to the nearest charging station 415. For example, the user computer device 235 may interact with a mapping application to map out a route from the current location 405 to the nearest charging station 415. Then the user computer device 235 uses that route to determine the second distance 425. The second distance 425 may include a buffer distance, such as 10% or five miles to ensure that the vehicle 100 can travel that second distance 425.

In the exemplary embodiment, the user computer device 235 is programmed to provide a first alert to the user when the current available range of the vehicle is about to go below the first distance 420. The first alert may be audio, visual, and/or vibration to allow the user to know that if the power exporter 200 is continued to be used, the vehicle 100 will not make it to the home location 410 without requiring charging.

The user computer device 235 provides a second alert to the user with the current available range of the vehicle 100 is about to go below the second distance 425. The second alert may be audio, visual, and/or vibration to allow the user to know that if the power exporter 200 is continued to be used, the vehicle 100 will not be able to travel to the nearest charging station. In the exemplary embodiment, the user computer device 235 will instruct the power exporter 200 to stop transmitting power from the vehicle 100. In some embodiments, the user can overrule these instructions, such as by pressing one or more controls 225 (shown on FIG. 2) or by interacting with the user computer device 235. For example, the user may be in an emergency situation and need the power.

While in the above description, the calculations are performed by the user computer device 235, in other embodiments, the calculations are performed by the power exporter 200. In these embodiments, power exporter 200 receives the first distance 420 and the second distance 425 either directly from the user and/or through the user computer device 235. The power exporter 200 then compares the current available range of the vehicle 100 to the first distance 420 and the second distance 425. In these embodiments, the power exporter 200 may transmit alerts to the user computer device 235. In some embodiments, the power exporter 200 displays the current status (first alert and second alert) through the status displays 320 (shown in FIG. 3). For example, a status display 320 may be an LED light that glows a first color (green) when the current available range is greater than the first distance 420. The LED light (or another LED light) glows a second color (yellow) when the current available range is between the first distance 420 and the second distance 425. And the LED light (or another LED light) glows a third color (red) when the current available range reaches the second distance 425. In these embodiments, the power exporter 200 stops transmission of power from the vehicle 100 when the current available range reaches the second distance 425.

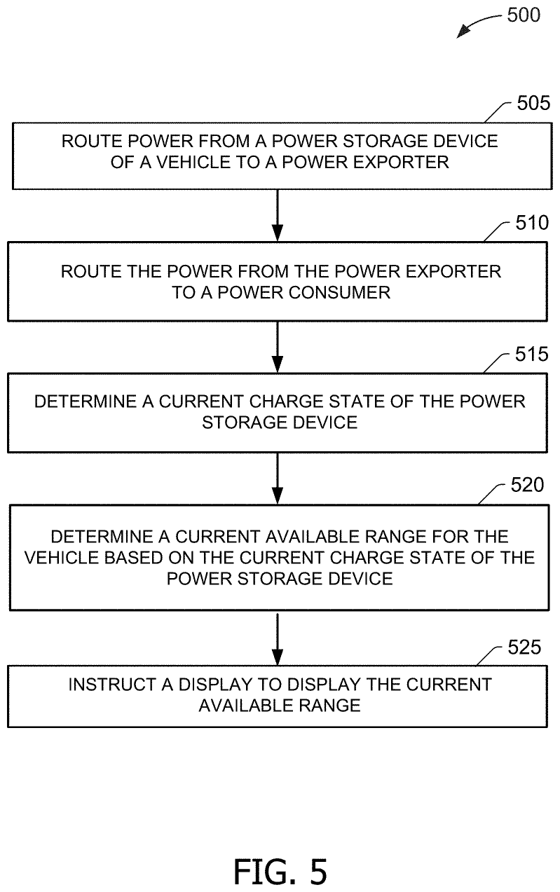

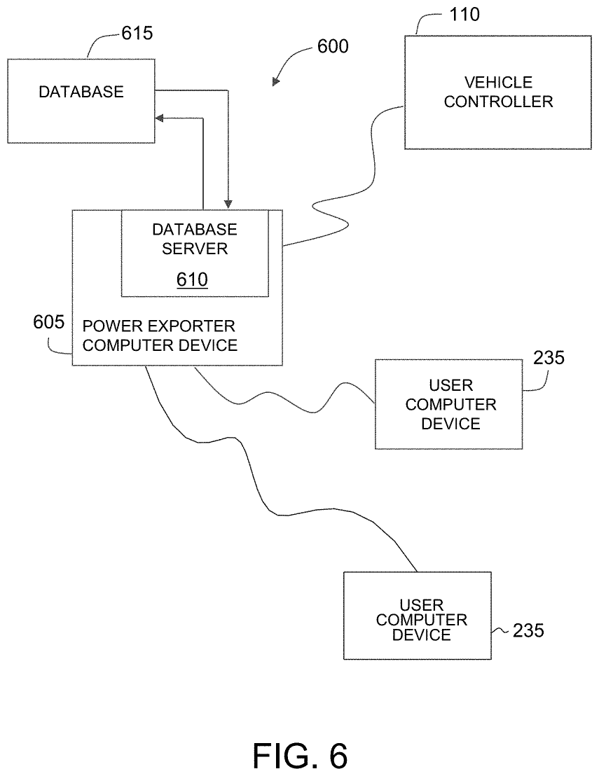

FIG. 5 illustrates an example process 500 for discharging power from the vehicle 100 (shown in FIG. 1) using the power exporter 200 (shown in FIG. 2). The steps of process 500 can be performed by the power exporter computer device 605 (shown in FIG. 6) and/or the user computer device 235 (shown in FIG. 2). In the exemplary embodiment, some steps of process 500 are performed by the power exporter computer device 605 and some steps of process 500 are performed by the user computer device 235, where the power exporter computer device 605 and the user computer device 235 are in wireless communication with each other.

In the exemplary embodiment, the power exporter computer device 605 routes 505 power from a power storage device 105 (shown in FIG. 1) of a vehicle 100 to the power exporter 200. And then the power exporter computer device 605 routes 510 the power from the power exporter 200 to a power consumer 130 (shown in FIG. 1). As shown in FIG. 1, the power routes from the power storage device 105 to the inlet/outlet 120 (shown in FIG. 1) of the vehicle 100. The power then routes to the power exporter 200 and through a cord 135 to a power consumer 130, such as an electrical appliance.

In the exemplary embodiment, the power exporter computer device 605 determines 515 a current charge state of the power storage device 105. The current charge state may be communicated by the vehicle 100 and/or the vehicle controller 110 to the power exporter computer device 605. In some embodiments, the inlet/outlet 120 and the inlet 210 include one or more communication lines that allows the vehicle controller 110 to output information along with electrical power.

In the exemplary embodiment, the power exporter computer device 605 determines 520 a current available range for the vehicle 100 based on the current charge state of the power storage device 105. In other embodiments, the power exporter computer device 605 transmits the current charge state to the user computer device 235 and the user computer device 235 determines 520 the current available range for the vehicle 100 based on the current charge state of the power storage device 105. In some embodiments, the user computer device 235 and/or the power exporter computer device 605 stores one or more values for the fuel economy of the vehicle 100. The one or more values may be based on actual observations for the vehicle 100 in question. The one or more values may be associated with the type of vehicle 100 and based on the average fuel economy for vehicles 100 of that make, model, and/or year.

In the exemplary embodiment, the power exporter computer device 605 instructs 525 a display 220 to display the current available range. In some embodiments, the power exporter computer device 605 transmits the current available range to the user computer device 235, for the user computer device 235 to display. In other embodiments, the user computer device 235 transmits the current available range to the power exporter computer device 605.

In some embodiments, the power exporter computer device 605 and/or the user computer device 235 compares the current available range to the amount of range required to get the vehicle 100 back to a home location 410 or to a nearby charging station 415 (both shown in FIG. 4). In the exemplary embodiment, the user computer device 235 includes a GPS or other location services, which allow the user computer device 235 to determine its current location 405, and thus the current location 405 of the vehicle 100. The user computer device 235 also stores a home location 410 for the vehicle 100. The home location 410 could be a family home, an office, a rental facility, a hotel, or another campsite. The home location 410 represents a location that the user desires to go to next.

In the exemplary embodiment, the user computer device 235 uses a mapping or other routing program to determine a route from the current location 405 to the home location 410. The user computer device 235 uses that route to determine the first distance 420 from the current location 405 to the home location 410. The first distance 420 may include a buffer, such as 5 miles or 10% to allow for a safety margin in the first distance 420. The user computer device 235 compares the first distance 420 to the current available range. In some embodiments, the user computer device 235 continually monitors the comparison and notifies the user when the first distance is about to exceed the current available range, in other words, when it is about to require charging to drive the vehicle 100 from the current location 405 to the home location 410.

In some embodiments, the power exporter computer device 605 instructs the display 220 to display a first indicator if the current available range exceeds the first distance 420. The power exporter computer device 605 also instructs the display 220 to display a second indicator if the first distance 420 exceeds the current available range. For example, the first indicator can be a green light and the second indicator can be a yellow light. In some embodiments, the power exporter computer device 605 receives the first distance 420 from the user computer device 235 and performs the comparisons. In other embodiments, the user computer device 235 notifies the power exporter computer device 605 when the first distance exceeds the current available range.

The user computer device 235 either stores a plurality of charging station locations or can look up locations of charging stations 415. In some embodiments, the user computer device 235 picks the nearest charging station 415. In other embodiments, the user computer device 235 selects the nearest charging station 415 based on the direction of travel to the home location 410. In these embodiments, the user computer device 235 determines how far out of the user's way each charging station 415 is. In still other embodiments, the user computer device 235 displays the nearby charging stations 415 and allows the user to select one. In the exemplary embodiment, the user computer device 235 uses a mapping or other routing program to determine a route from the current location 405 to the charging station 415. The user computer device 235 uses that route to determine the second distance 425 from the current location 405 to the charging station 415. The second distance 425 may include a buffer, such as 5 miles or 10% to allow for a safety margin in the second distance 425. The user computer device 235 compares the second distance 425 to the current available range. In some embodiments, the user computer device 235 continually monitors the comparison and notifies the user when the second distance is about to exceed the current available range, in other words, when the current available range is not enough to drive to the nearby charging station 415.

In some embodiments, the power exporter computer device 605 instructs the display 220 to display a third indicator if the first distance 420 exceeds the current available range and the second distance 425 matches the current available range. For example, the third indicator can be a red light. In some embodiments, the power exporter computer device 605 receives the second distance 425 from the user computer device 235 and performs the comparisons. In other embodiments, the user computer device 235 notifies the power exporter computer device 605 when the second distance is about to exceed the current available range.

In the exemplary embodiment, when the second distance is about to exceed the current available range, the power exporter computer device 605 disables the flow of power to the power consumer 130 to prevent the current available range from going below the second distance, to allow the user to drive to the charging station 415. However, in an emergency, the user can override this disabling.

In some embodiments, the user computer device 235 and/or the power exporter computer device 605 can determine and display an amount of time until the current available range no longer exceeds the first distance 420 and/or the second distance 425 based on the current rate of discharge of the power storage device 105. This would inform the user how long they can use the power storage device 105 at their current rate. This may cause users to turn off different power consumers 130 to extend the lifespan of the charge of the power storage device 105.

FIG. 6 illustrates a simplified block diagram of a power exporter system 600 for monitoring and controlling discharging power from the vehicle 100 (shown in FIG. 1) using the power exporter 200 (shown in FIG. 2). In the example, power exporter system 600 is used for controlling the operation of the power exporter 200 for controlling the flow of power from the attached vehicle 100 to one or more attached power consumers 130. The power exporter system 600 monitors the flow of power and prevents draining all of the power from the vehicle 100, so that the vehicle may have enough charge travel to a charging location, such as a charging station 415 or the home location 410 (both shown in FIG. 4).

The power exporter system 600 includes a power exporter computer device 605. The power exporter computer device 605 is included in the power exporter 200. The power exporter computer device 605 monitors and controls the flow of power from the inlet 210 to the outlet 215 (both shown in FIG. 2). The power exporter computer device 605 also controls the display 220 and receives inputs from the control 225 (both shown in FIG. 2). In the exemplary embodiment, the power exporter computer device 605 is in communication with the vehicle control 110. The power exporter computer device 605 receives the current charge state of the power storage device 105 (shown in FIG. 1) from one of the vehicle controller 110 and the power storage device 105. In some embodiments, the power exporter computer device 605 receives the information through the wired connection between the inlet 210 of the power exporter 200 and the inlet/outlet 120 of the vehicle 100.

In the exemplary embodiment, the power exporter computer device 605 is in wireless communication with the user computer device 235. The user computer device 235 can provide the power exporter computer device 605 with the first distance 420 and the second distance 425. In some embodiments, the user computer device 235 provides the current available range and other calculations to the power exporter computer device 605. In other embodiments, the power exporter computer device 605 performs the calculations in real-time.

One of the power exporter computer device 605 and the user computer device 235 can also be in communication with a database server 610 for retrieving and storing data in a database 615. The database server 610 is communicatively coupled to a database 615 that stores data. In one example, the database 615 includes a plurality of fuel and charge efficiency information for a plurality of different vehicles, a plurality of locations of different charging stations, and additional information about user computer devices 235. In some examples, the database 615 is stored remotely from the power exporter computer device 605. In some examples, the database 615 is decentralized. In the example, a person can access the database 615 via a user computer device 235 by logging onto a website or application associated with the power exporter 200.

In the example embodiments, the user computer devices 235 are computers that include a web browser or a software application, which enables the user computer device 235 to communicate with the power exporter computer device 605 using Bluetooth, Bluetooth low energy, frequency identification (RFID), magnetic loop induction, high frequency audio, or any other wireless communication. In some further examples, the user computer device 235 may directly connect to the power exporter computer device 605 using a direct wired connection, such as through the port outlet 310 (shown in FIG. 3). In some examples, the user computer devices 235 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The user computer devices 235 can be any device capable of accessing a network, such as the Internet, including, but not limited to, a desktop computer, a laptop computer, a personal digital assistant (PDA), a cellular phone, a smartphone, a tablet, a phablet, or other web-based connectable equipment. In at least one example, the user computer device 235 includes a web browser or application that can be used to output information to the power exporter computer device 605, such as to provide user settings and/or first distance 420 or second distance 425. In some examples, the user computer device 235 monitors the discharge of energy from the vehicle and further monitors the current charge state of the vehicle 100 to provide warnings when the different distance thresholds have been reached.

In the example embodiments, the power exporter computer devices 605 are computers that include a web browser or a software application, which enables the user computer device 235 to communicate with the power exporter computer device 605 using Bluetooth, Bluetooth low energy, frequency identification (RFID), magnetic loop induction, high frequency audio, or any other wireless communication. In some further examples, the user computer device 235 may directly connect to the power exporter computer device 605 using a direct wired connection, such as through the port outlet 310 (shown in FIG. 3). In some examples, the power exporter computer device 605 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The power exporter computer device 605 can be any device capable of accessing a network, such as the Internet, including, but not limited to, a desktop computer, a laptop computer, a personal digital assistant (PDA), a cellular phone, a smartphone, a tablet, a phablet, or other web-based connectable equipment. In at least one example, the power exporter computer device 605 includes a web browser or application that can be used to output information to the user computer device 235, such as to provide charge state information.

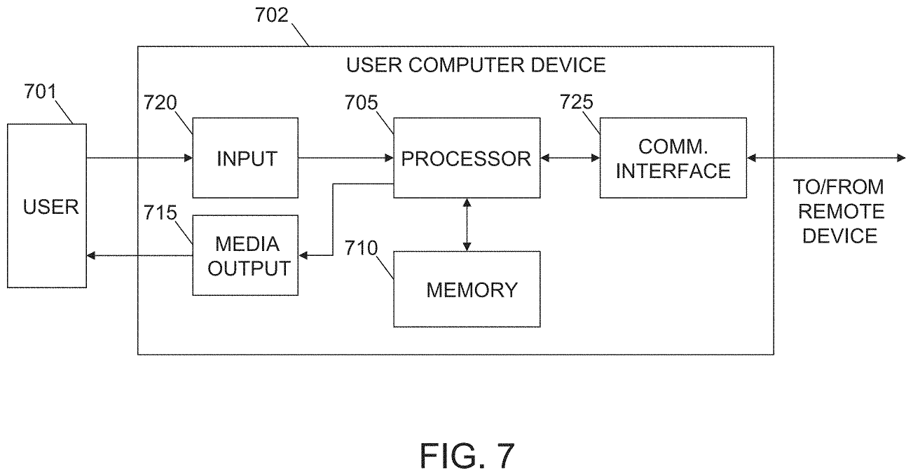

FIG. 7 illustrates an example configuration of a user computer device 702 used in the power exporter system 600 (shown in FIG. 6), in accordance with one example of the present disclosure. User computer device 702 is operated by a user 701. The user computer device 702 can include, but is not limited to, vehicle controller 110 (shown in FIG. 1), user computer device 235 (shown in FIG. 2), and power exporter computer device 605 (shown in FIG. 6). The user computer device 702 includes a processor 705 for executing instructions. In some examples, executable instructions are stored in a memory area 710. The processor 705 can include one or more processing units (e.g., in a multi-core configuration). The memory area 710 is any device allowing information such as executable instructions and/or transaction data to be stored and retrieved. The memory area 710 can include one or more computer-readable media.

The user computer device 702 also includes at least one media output component 715 for presenting information to the user 701. The media output component 715 is any component capable of conveying information to the user 701. In some examples, the media output component 715 includes an output adapter (not shown) such as a video adapter and/or an audio adapter. An output adapter is operatively coupled to the processor 705 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some examples, the media output component 715 is configured to present a graphical user interface (e.g., a web browser and/or a client application) to the user 701. A graphical user interface can include, for example, an interface for viewing the current available range of the vehicle 100 (shown in FIG. 1). In some examples, the user computer device 702 includes an input device 720 for receiving input from the user 701. The user 701 can use the input device 720 to, without limitation, turn on power and/or set one or more user settings. The input device 720 can include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen can function as both an output device of the media output component 715 and the input device 720.

The user computer device 702 can also include a communication interface 725, communicatively coupled to a remote device such as the power exporter computer device 605 and the user computer device 235. The communication interface 725 can include, for example, a wired or wireless network adapter and/or a wireless data transceiver for use with a mobile telecommunications network.

Stored in the memory area 710 are, for example, computer-readable instructions for providing a user interface to the user 701 via the media output component 715 and, optionally, receiving and processing input from the input device 720. A user interface can include, among other possibilities, a web browser and/or a client application. Web browsers enable users, such as the user 701, to display and interact with media and other information typically embedded on a web page or a website from the user computer device 235. A client application allows the user 701 to interact with, for example, the power exporter computer device 605. For example, instructions can be stored by a cloud service, and the output of the execution of the instructions sent to the media output component 715.

The processor 705 executes computer-executable instructions for implementing aspects of the disclosure.

As used herein, a processor can include any programmable system including systems using micro-controllers; reduced instruction set circuits (RISC), application-specific integrated circuits (ASICs), logic circuits, and any other circuit or processor capable of executing the functions described herein. The above examples are example only, and are thus not intended to limit in any way the definition and/or meaning of the term “processor.”

As used herein, the term “cybersecurity threat” includes an unauthorized attempt to gain access to a subject system. Cybersecurity threats, also known as cyber-attacks or cyber-threats, attempt to breach computer systems by taking advantage of vulnerabilities in the computer systems. Some cybersecurity threats include attempts to damage or disrupt a subject system. These cybersecurity threats can include, but are not limited to, active intrusions, spyware, malware, viruses, and worms. Cybersecurity threats may take many paths (also known as attack paths) to breach a system. These paths may include operating system attacks, misconfiguration attacks, application level attacks, and shrink wrap code attacks. Cybersecurity threats may be introduced by individuals or systems directly accessing a computing device, remotely via a communications network or connected system, or through an associated supply chain.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Wash.). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, Calif.). In yet a further example, the system is run on a Mac OS® environment (Mac OS is a registered trademark of Apple Inc. located in Cupertino, Calif.). In still yet a further example, the system is run on Android® OS (Android is a registered trademark of Google, Inc. of Mountain View, Calif.). In another example, the system is run on Linux® OS (Linux is a registered trademark of Linus Torvalds of Boston, Mass.). The application is flexible and designed to run in various different environments without compromising any major functionality.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

The patent claims at the end of this document are not intended to be construed under 35 U.S.C. § 112(f) unless traditional means-plus-function language is expressly recited, such as “means for” or “step for” language being expressly recited in the claim(s).

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The methods and system described herein can be implemented using computer programming or engineering techniques including computer software, firmware, hardware, or any combination or subset. As disclosed above, at least one technical problem with prior systems is that there is a need for systems for monitoring communication networks, where the networks can change over time. The system and methods described herein address that technical problem. Additionally, at least one of the technical solutions to the technical problems provided by this system can include: (i) reduced weight in power exporters; (ii) allowing use of the power of the vehicle in case of an emergency; (iii) improved safety in ensuring that the vehicle will not be completely drained of power; (iv) improved notification of the user of the current charge state and available driving range with the current charge state; and (v) flexible notifications.

The methods and systems described herein can be implemented using computer programming or engineering techniques including computer software, firmware, hardware, or any combination or subset thereof, wherein the technical effects can be achieved by performing at least one of the following steps: a) determine a current charge state of the power storage device; b) determine a current available range for the vehicle based on the current charge state of the power storage device; c) instruct said display to display the current available range; d) determine a first distance to a home location; e) compare the first distance to the current available range; f) transmit a notification to a user computer device when the first distance exceeds the current available range; g) instruct said display to display a first indicator if the current available range exceeds the first distance; h) instruct said display to display a second indicator if the first distance exceeds the current available range; i) determine a second distance to a charging station; j) compare the second distance to the current available range; k) disable transmission of power between said power inlet and said power outlet based on the comparison; l) determine if the current available range exceeds the second distance by less than a predetermined amount; and m) if the current available range exceeds the second distance by less than a predetermined amount, transmit a notification to a user computer device.

In some additional embodiments, the technical effects can be achieved by performing at least one of the following steps: a) routing power from a power storage device of a vehicle to a power exporter; b) routing power from the power exporter to a power consumer; c) determining a current charge state of the power storage device; d) determining a current available range for the vehicle based on the current charge state of the power storage device; e) instructing a display to display the current available range; f) transmitting, via a communication interface, the current available range to a user computer device, where the user computer device is configured display the current available range to a user; g) determining a first distance to a home location; h) comparing the first distance to the current available range; i) transmitting a notification to a user when the first distance exceeds the current available range; j) instructing the display to display a first indicator if the current available range exceeds the first distance; k) instructing the display to display a second indicator if the first distance exceeds the current available range; l) determining a second distance to a charging station; m) comparing the second distance to the current available range; n) disabling transmission of power between the power storage device and the power consumer based on the comparison; o) determining if the current available range exceeds the second distance by less than a predetermined amount; and p) if the current available range exceeds the second distance by less than a predetermined amount, transmitting a notification to a user.

In some further embodiments, the technical effects can be achieved by performing at least one of the following steps: a) receive, from the power exporter, a current charge state of the power storage device; b) determine a current available range for the vehicle based on the current charge state of the power storage device; c) instruct a display of at least one of the power exporter and the user computer device to display the current available range; d) transmit the current available range to the power exporter for display; e) store a home location; 0 determine a current location of the vehicle; g) determine a first distance to the home location from the current location; h) compare the first distance to the current available range; i) determine a location of a charging station; j) determine a route to the location of the charging station from the current location; k) determine a second distance based on the route to the charging station; l) compare the second distance to the current available range; m) instruct the power exporter to disable transmission of power between the power storage device and the power consumer based on the comparison; n) determine a rate of discharge of the power storage device; and o) determine and display an amount of time until the first distance exceeds the current available range.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein can include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein can be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose various implementations, including the best mode, and also to enable any person skilled in the art to practice the various implementations, including making and using any devices or systems and performing any incorporated methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A device for providing power comprising:
a power inlet electrically connected to a power storage device of a vehicle;
a power outlet configured to be connected to a power consumer, wherein power is being routed from the power storage device of the vehicle to said power inlet and out of said power outlet to the power consumer;
a display; and
at least one processor in communication with at least one memory device, wherein the at least one processor is programmed to:
determine a current charge state of the power storage device;
determine a current available range for the vehicle based on the current charge state of the power storage device; and
instruct said display to display the current available range.

2. The device of claim 1, wherein the at least one processor is further programmed to:
determine a first distance to a home location; and
compare the first distance to the current available range.

3. The device of claim 2, wherein the at least one processor is further programmed to:
transmit a notification to a user computer device when the first distance exceeds the current available range.

4. The device of claim 2, wherein the at least one processor is further programmed to:
instruct said display to display a first indicator if the current available range exceeds the first distance; and
instruct said display to display a second indicator if the first distance exceeds the current available range.

5. The device of claim 1, wherein the at least one processor is further programmed to:
determine a second distance to a charging station; and
compare the second distance to the current available range.

6. The device of claim 5, wherein the at least one processor is further programmed to disable transmission of power between said power inlet and said power outlet based on the comparison.

7. The device of claim 5, wherein the at least one processor is further programmed to:
determine if the current available range exceeds the second distance by less than a predetermined amount; and
if the current available range exceeds the second distance by less than a predetermined amount, transmit a notification to a user computer device.

8. A method for providing power comprising:
routing power from a power storage device of a vehicle to a power exporter;
routing power from the power exporter to a power consumer;
determining a current charge state of the power storage device;
determining a current available range for the vehicle based on the current charge state of the power storage device; and
transmitting, via a communication interface, the current available range to a user computer device, wherein the user computer device is configured display the current available range to a user.

9. The method of claim 8 further comprising:
determining a first distance to a home location; and
comparing the first distance to the current available range.

10. The method of claim 9 further comprising:
transmitting a notification to a user when the first distance exceeds the current available range.

11. The method of claim 9 further comprising:
instructing the display to display a first indicator if the current available range exceeds the first distance; and
instructing the display to display a second indicator if the first distance exceeds the current available range.

12. The method of claim 8 further comprising:
determining a second distance to a charging station; and
comparing the second distance to the current available range.

13. The method of claim 12 further comprising disabling transmission of power between the power storage device and the power consumer based on the comparison.

14. The method of claim 12 further comprising:
determining if the current available range exceeds the second distance by less than a predetermined amount; and
if the current available range exceeds the second distance by less than a predetermined amount, transmitting a notification to a user.

15. A system for providing power comprising:
a power exporter configured to route power from a power storage device of a vehicle to a power consumer; and
a user computer device in communication with the power exporter, wherein the user computer device comprises at least one processor in communication with at least one memory device, wherein the at least one processor is programmed to:
receive, from the power exporter, a current charge state of the power storage device;
determine a current available range for the vehicle based on the current charge state of the power storage device; and
instruct a display of at least one of the power exporter and the user computer device to display the current available range.

16. The system of claim 15, wherein the at least one processor is further programmed to transmit the current available range to the power exporter for display.

17. The system of claim 15, wherein the at least one processor is further programmed to:
store a home location;
determine a current location of the vehicle;
determine a first distance to the home location from the current location; and
compare the first distance to the current available range.

18. The system of claim 17, wherein the at least one processor is further programmed to:
determine a location of a charging station;
determine a route to the location of the charging station from the current location;
determine a second distance based on the route to the charging station; and
compare the second distance to the current available range.

19. The system of claim 18, wherein the at least one processor is further programmed to instruct the power exporter to disable transmission of power between the power storage device and the power consumer based on the comparison.

20. The system of claim 16, wherein the at least one processor is further programmed to:
determine a rate of discharge of the power storage device; and
determine and display an amount of time until the first distance exceeds the current available range.
